(19) United States
(12) Patent Application Publication
(10) Pub. No.: US 2024/0203055 A1
(43) Pub. Date: Jun. 20, 2024

(54) REPRESENTING FLAT SURFACES IN POINT-BASED REPRESENTATIONS OF PHYSICAL ENVIRONMENTS

(71) Applicant: APPLE INC., Cupertino, CA (US)

(72) Inventors: Long H. NGO, San Jose, CA (US); Alexandre DA VEIGA, San Francisco, CA (US)

(21) Appl. No.: 18/582,757

(22) Filed: Feb. 21, 2024

Related U.S. Application Data
(63) Continuation of application No. PCT/US2022/041627, filed on Aug. 26, 2022.
(60) Provisional application No. 63/242,539, filed on Sep. 10, 2021.

(51) Int. Cl. G06T 17/20

(52) U.S. Cl. CPC G06T 17/20

(57) ABSTRACT

Various implementations disclosed herein include devices, systems, and methods that generate a 3D representation of a physical environment by generating a point cloud and selectively replacing some of the points. For example, points representing flat surfaces (e.g., walls and ceilings) may be replaced with planar elements that are “painted” using image data. In contrast, points representing non-flat portions (e.g. furniture, curtains, wall hangings, etc.) are left as points in the model or altered in a different way. Selectively altering the 3D representation may provide (a) a cleaner feeling and/or (b) a more compact 3D representation for more efficient and faster communication and/or rendering.

### CROSS-REFERENCE TO RELATED APPLICATIONS

This application is a continuation of International Application No. PCT/US2022/041627 (International Publication No. WO2023/038808) filed on Aug. 26, 2022, which claims priority to U.S. Provisional Application No. 63/242,539 filed on Sep. 10, 2021, both entitled “REPRESENTING FLAT SURFACES IN POINT-BASED REPRESENTATIONS OF PHYSICAL ENVIRONMENTS,” each of which is incorporated herein by this reference in its entirety.

### TECHNICAL FIELD

The present disclosure generally relates to electronic devices that use sensors to provide views of physical environments, including views that include representations of the physical environments used in live communication sessions.

### BACKGROUND

Various techniques are used to generate 3D representations of physical environments. For example, a point cloud or 3D mesh may be generated to represent portions of a physical environment. Existing techniques may not adequately facilitate capturing and/or sharing 3D representations of physical environments. For example, the appearance of points in a 3D representation may be granular or may otherwise not adequately represent the appearance of portions of a physical environment.

### SUMMARY

Various implementations disclosed herein include devices, systems, and methods that generate a 3D representation of a physical environment by generating a point cloud and selectively replacing some of the points. For example, points representing flat surfaces (e.g., walls and ceilings) may be replaced with planar elements that are “painted” using image data. In contrast, points representing non-flat portions (e.g. furniture, curtains, wall hangings, etc.) are left as points in the model or altered in a different way. Selectively altering the 3D representation to replace certain points with planar elements may provide (a) a cleaner feeling and/or (b) a more compact 3D representation for more efficient and faster communication and/or rendering.

In some implementations, a processor performs a method by executing instructions stored on a computer readable medium. The method generates a 3D representation of a physical environment, where the 3D representation has points each having a 3D location and representing a portion of the physical environment. The method identifies a first set of the points of the 3D representation satisfying a replacement criterion. For example, this may involve identifying the first set of points based on a confidence level that the points represent a single flat surface of the physical environment. This may be determined based on the distance between each point and the flat surface. In a similar example, this may involve identifying whether the first set of points are part of a flat surface of sufficient size. The method replaces the first set of the points in the 3D representation with a planar element having an appearance provided by an image depicting a surface of the physical environment. For example, this may involve replacing wall points with a plane “painted” using an image of the wall. The appearance may be updated during a scanning process during which a 3D representation/model is updated and refined as new sensor data is obtained, e.g., where new point data is used to add new points, ignored as duplicative of existing points, used to replace existing points, used to add or extend planar regions, or ignored as representing a portion of planar region already represented. The replacing may reduce the size of the 3D representation, e.g., potentially replacing hundreds or thousands of points with a relatively small number of parametrically-defined planar elements.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary an electronic device operating in a physical environment in accordance with some implementations.

FIG. 2 illustrates a depiction of a 3D representation of the physical environment of FIG. 1 in accordance with some implementations.

FIG. 3 illustrates a view of the 3D representation of FIG. 2 with a subset of points replaced by planar elements in accordance with some implementations.

FIG. 4 is a flowchart illustrating a method for generating a point cloud and selectively replacing some of the points with planar elements in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

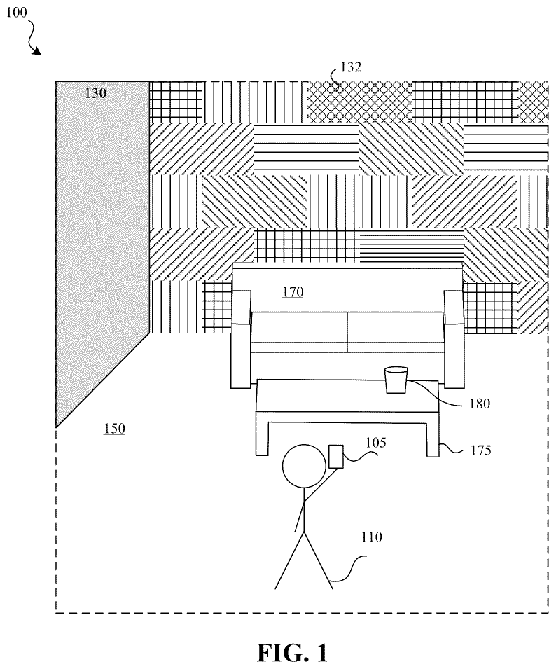

FIG. 1 illustrates an exemplary electronic device 105 operating in a physical environment 100. The electronic device may be (but is not necessarily) involved in a communication session, e.g., the electronic device 105 may be communicating with one or more other electronic devices (not shown) which are transmitting information with one another or an intermediary device such as a communication session server. In this example of FIG. 1, the physical environment 100 is a room that includes walls (e.g., wall 130 and wall 132), a ceiling (not shown), a floor 150, a couch 170, a table 175, and a coffee cup 180. Wall 132 includes a pattern of rectangular regions of different colors.

The electronic device 105 includes one or more cameras, microphones, depth sensors, or other sensors that can be used to capture information about and evaluate the physical environment 100 and the objects within it, as well as information about the user 110 of the electronic device 105. The information about the physical environment 100 and/or user 110 may be used to provide visual and audio content, for example, during a communication session. For example, a communication session may provide views to one or more participants (e.g., user 110 and/or other participants not shown) of a 3D environment that is generated based on camera images and/or depth sensor images of the physical environment 100 as well as a representation of user 110 based on camera images and/or depth sensor images of the user 110.

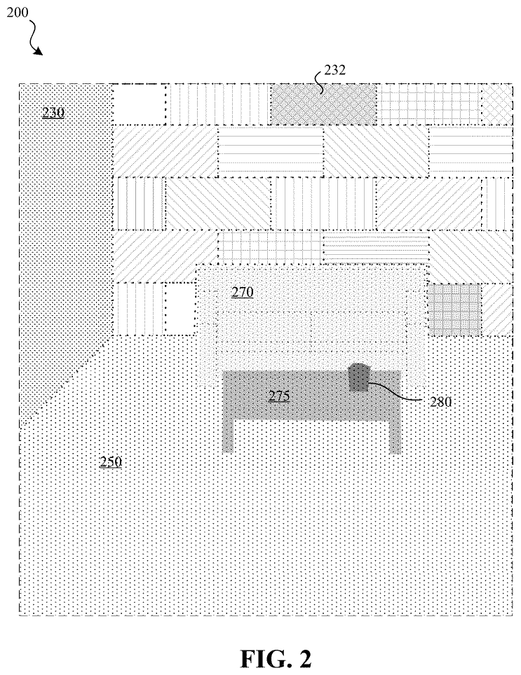

FIG. 2 illustrates a depiction 200 of a 3D representation of the physical environment 100 of FIG. 1. In this example, points 230 correspond to wall 130, points 232 correspond to wall 132, points 250 correspond to floor 150, points 270 correspond to couch 170, points 275 correspond to table 175, and points 280 correspond to coffee cup 180. Note that an actual 3D representation (e.g., 3D point cloud, 3D mesh, etc.) may have more variable, less consistently spaced element locations, more or fewer elements or otherwise differ from the depiction 200 which is provided as an illustration rather than a spatially-accurate portrayal of an actual 3D point cloud. Points of a 3D representation, for example, may correspond to depth values measured by a depth sensor and thus may be more sparse for objects farther from the sensor than for objects closer to the sensor. Each of the points of the 3D representation corresponds to a location in 3D a coordinate system and has a characteristic (e.g., color) indicative of an appearance of a corresponding portion of the physical environment 100. In some implementations, an initial 3D representation is generated based on sensor data and then an improvement process is performed to improve the 3D representation, e.g., by filling holes, performing densification to add points to make the representation denser, etc.

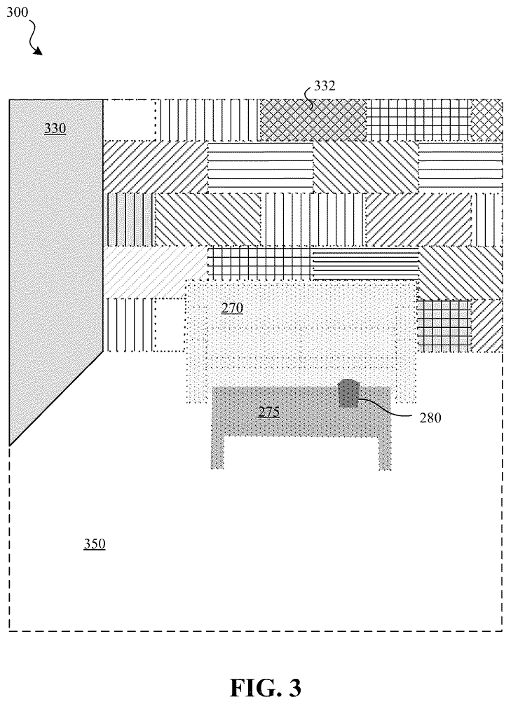

FIG. 3 illustrates a view of the 3D representation of FIG. 2 with some points replaced with planar elements. Points 230 corresponding to wall 130 have been replaced with a planar element 330. Points 232 corresponding to wall 132 have been replaced with a planar element 332. Points 250 corresponding to floor 150 have been replaced with a planar element 350. In some implementations, planar elements are used individually to represent perimeter regions (e.g., walls, ceilings, floors) of a physical environment. In other implementations, alternative geometric shapes are used. For example, a cylindrical shape may be used to represent a cylindrical pillar. In some implementations, the device determines a room layout based on sensor data, identifies flat areas within the room based on the room layout, and selects planar elements to replace points based on the identified flat areas with the room.

In the example of FIG. 3, while points 230, 232, 250 are replaced with planar elements, other points (e.g., points 270 representing the couch, points 275 representing the table 175, and points 280 representing the coffee cup 180) remain included within the 3D representation. In some implementations, such other points are altered in another way (e.g., a point densification process) to improve the appearance of a representation. The view 300 may be provided based on these remaining points 270, 275, 280 and the planar elements 330, 332, 350. In this example, appearance of each of the planar elements 330, 332, 350 is based on image data of the physical environment 100. For example, image data of the wall 132 may capture the pattern of rectangular regions of different colors on wall 132. In some implementations, one or more images are combined together to provide an image used to “paint,” define a texture of, or otherwise specify the appearance of a planar element. For example, a portion of a first image of a left side of wall 132 may be aligned with and stitched together with a second image of a right side of wall 132 to form a single image that is used to provide the appearance of planar element 332. In other examples, pixels from the first and second image may be assigned a quality score based on any number of factors, such as capture conditions including capture angle, distance, lighting, etc. Pixels having higher quality scores may be selected and/or pixels having similar quality scores may be combined for inclusion in the final image.

The 3D representation may include or be associated with the planar elements and this information may be provided during the communication session to a rendering engine on device 105 or other devices involved in a communication session. Providing the 3D representation to other devices involved in a communication session may allow users of those devices to view the 3D representation and thereby feel as though they are in the same physical environment 100 as user 110. The points and planar element information are used to provide views that include both point-based representations of certain objects and planar-element representations of flat surfaces, e.g., as illustrated in the view 300 of FIG. 3.

Selectively altering the 3D representation to replace certain points, as illustrated in FIG. 3, may provide a cleaner feeling, a more solid feeling, a more enclosed feeling, and/or a lighter feeling environment. Altering the 3D representation may additionally provide a more compact 3D representation for more efficient and faster communication and rendering.

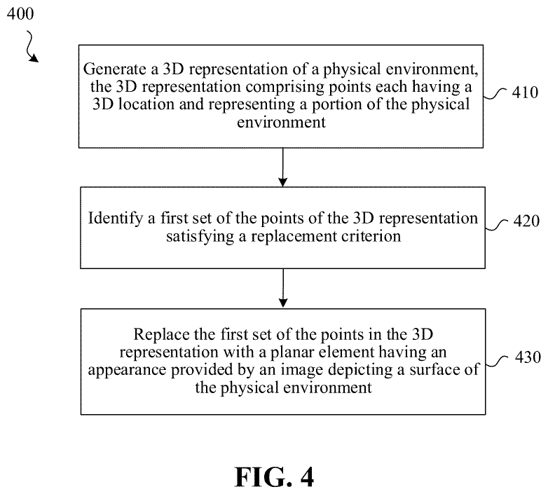

FIG. 4 is a flowchart illustrating a method 400 for generating a point cloud and selectively replacing some of the points with planar elements. In some implementations, a device such as electronic device 105 performs method 400. In some implementations, method 400 is performed on a mobile device, desktop, laptop, HMD, car-mounted device or server device. The method 400 is performed by processing logic, including hardware, firmware, software, or a combination thereof. In some implementations, the method 400 is performed on a processor executing code stored in a non-transitory computer-readable medium (e.g., a memory).

At block 410, the method 400 generates a three-dimensional (3D) representation (e.g., a 3D point cloud, a 3D mesh, etc.) of a physical environment, the 3D representation including points (e.g., points of a point cloud or points defining polygons of a mesh) each having a 3D location and used to represent an appearance (e.g., color) of a portion of the physical environment. In some examples, the points further include color, semantic, or other information. In one example, a 3D point cloud of the room is generated during a communication session. In such a communication session, avatars or other user representations of the communication session may be (but need not be) positioned within the 3D representation as part of a providing a shared environment experience to multiple users.

A block 420, the method 400 identifies a first set of points of the 3D representation satisfying a replacement criterion. This may involve using a machine learning model or algorithm to identify portions of a point cloud corresponding to a flat surface of the physical environment. Attributes of such a flat surface may also be determined. For example, the size, shape, and/or irregularities of a flat surface may be assessed. In some implementations, identifying the first set of points comprises identifying points likely (e.g., above a threshold level of confidence) to be on a flat surface, identifying that the flat surface has at least a threshold size, identifying that the flat surface has a shape that satisfies a criterion, and/or identifying that the flat surface has a characteristic, e.g., sufficient flatness, lack of irregularities, transparency level, etc. In some implementations, identifying which points satisfy the replacement criterion is based on sensor data from an active depth sensor and/or an image sensor (e.g., and RGB camera). In some implementations, a flat surface is identified based on sensor data and individual points are determined to be on the flat surface or separate from the flat surface based on their respective distances from the flat surface, e.g., based on a distance threshold.

At block 430, the method 400 replaces the first set of the points in the 3D representation with a planar element having an appearance provided by an image depicting a surface of the physical environment. A planar element may be defined using location/orientation information (e.g., a 6 DOF pose) and information identifying shape type, size, color, texture, image, etc. An image providing the appearance of a planar element may be generated based on one or more images of the corresponding flat surface of the physical environment.

In some implementations, a planar element corresponds to a window, door, glass wall, or other element through which light and/or extra-room content is visible. Such a visual feature may have a characteristic that corresponds to or is otherwise based upon the physical environment. For example, a window to an external (sunny) landscape may have a bright appearance corresponding to the lighter external environment. External content visible through such an element may be blurred or otherwise obscured to provide a sense of the general environment without revealing details, e.g., grass and landscaping may appear as a blurry green/brown region, the sky may appear as a blurry blue/white region, etc. Blurring and obscuring content may provide a more desirable user experience as well as provide sharing in accordance with the users' privacy requirements, preferences, consents, and permissions.

In some implementations, an edge treatment is performed to blend the appearance of point cloud points with nearby portions of a planar element. For example, transition points near the edge of a planar region may be added to provide a more continuous appearance. In another example, points associated with an object touching (e.g., on top of, resting against etc.) are modified based on determining that the object represented by the points is touching the planar surface. For example, such points may be modified to improve a transition, e.g., providing a straight edge along the boundary where the objects are touching, etc.

In some implementations, a planar element of a 3D representation of a physical environment is updated with new image data over time. For example, if a better and/or newer image of the corresponding flat surface of the physical environment is obtained during a communication session, the second image may replace or otherwise be used to update the appearance provided by the prior image. In some implementations, the appearance of a flat surface is determined, e.g., painted, and, over time, the quality of each pixel is calculated and tracked, e.g., using an arbitrary scoring system based on capture conditions such as capture angle, distance, lighting, etc. When new image data is obtained, the system may determine which pixels are to be replaced or refined, based on their new and old quality scores to provide an appearance in which each pixel is provided with the highest quality.

In some implementations, new image data is used automatically based on determining that the new image data satisfies a criterion, e.g., sufficient lighting during image capture, appropriate viewing angle relative to the surface (e.g., not too oblique to distort appearance) during image capture, limited occlusion, etc. The appearance of the flat surface may change over time, e.g., based on shadows occurring, lighting changes, etc. Updating the image of a planar element over time may thus help ensure that the planar element represents or otherwise provides an accurate or otherwise current/recent depiction of the corresponding portion of the physical environment.

In some implementations, a planar element is represented by a mesh that is given a texture based on one or more images. For example, a mesh may be divided into patches that are each painted with a respective patch of pixel data obtained from one or more images.

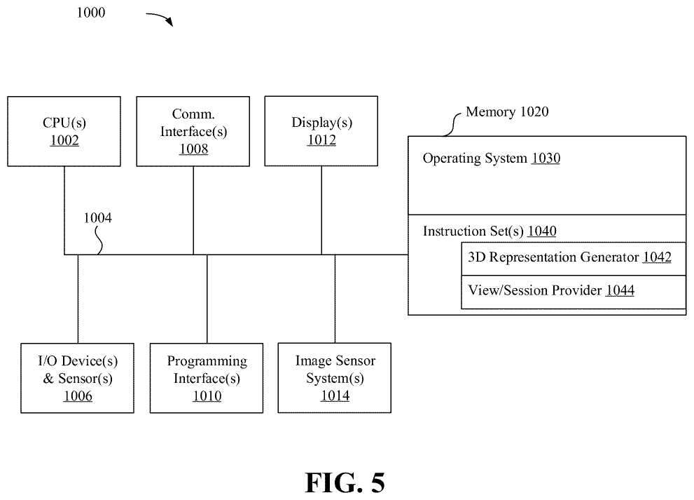

FIG. 5 is a block diagram of electronic device 1000. Device 1000 illustrates an exemplary device configuration for electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICS, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include 3D representation generator instruction set 1042 configured to, upon execution, generate and/or transmit a representation of a physical environment, for example, during a communication session, as described herein.

The instruction set(s) 1040 further include view/session provider instruction set 1044 configured to, upon execution, determine to provide a view of a 3D environment as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

The described technology may gather and use information from various sources. This information may, in some instances, include personal information that identifies or may be used to locate or contact a specific individual. This personal information may include demographic data, location data, telephone numbers, email addresses, date of birth, social media account names, work or home addresses, data or records associated with a user's health or fitness level, or other personal or identifying information.

The collection, storage, transfer, disclosure, analysis, or other use of personal information should comply with well-established privacy policies or practices. Privacy policies and practices that are generally recognized as meeting or exceeding industry or governmental requirements should be implemented and used. Personal information should be collected for legitimate and reasonable uses and not shared or sold outside of those uses. The collection or sharing of information should occur after receipt of the user's informed consent.

It is contemplated that, in some instances, users may selectively prevent the use of, or access to, personal information. Hardware or software features may be provided to prevent or block access to personal information. Personal information should be handled to reduce the risk of unintentional or unauthorized access or use. Risk can be reduced by limiting the collection of data and deleting the data once it is no longer needed. When applicable, data de-identification may be used to protect a user's privacy.

Although the described technology may broadly include the use of personal information, it may be implemented without accessing such personal information. In other words, the present technology may not be rendered inoperable due to the lack of some or all of such personal information.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

1. A method comprising:
at a processor of a first device:
generating a three-dimensional (3D) representation of a physical environment, the 3D representation comprising points each having a 3D location and representing a portion of the physical environment;
identifying a first set of the points of the 3D representation satisfying a replacement criterion; and
replacing the first set of the points in the 3D representation with a planar element having an appearance provided by one or more images depicting a surface of the physical environment.

2. The method of claim 1 further comprising providing the 3D representation to a second device different than the first device, wherein the second device provides a view based on the points and the planar element, wherein an appearance of the planar element in the view is based on the one or more images of the surface.

3. The method of claim 2, wherein the first device and the second device concurrently provide views of the physical environment during a communication session.

4. The method of claim 1, where the surface is a flat surface, wherein the planar element comprises a mesh defining the flat surface, wherein an appearance of the mesh is defined based on the one or more images.

5. The method of claim 1, wherein the planar element is defined using less data than the first set of the points.

6. The method of claim 1, wherein the first set of the points is identified by:
determining a confidence value that each point of the first set of the points represents a portion of a flat surface; and
determining that the confidence value of each point of the first set of the points exceeds a threshold.

7. The method of claim 6, wherein the first set of the points is further identified based on determining that the flat surface exceeds a size threshold.

8. The method of claim 1, wherein the replacing occurs in real time during a scanning process in which:
sensor data is obtained over a time period;
active depth sensing and imaging are used to generate the points for inclusion in the 3D representation as sensor data is received during the time period; and
points are selectively replaced with one or more planar elements based on the replacement criterion during the time period.

9. The method of claim 1 further comprising updating an appearance of the planar element as new sensor data is obtained.

10. The method of claim 9, wherein updating the appearance of the planar element is based on determining that the new sensor data satisfies an image criterion.

11. A first device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
generating a three-dimensional (3D) representation of a physical environment, the 3D representation comprising points each having a 3D location and representing a portion of the physical environment;
identifying a first set of the points of the 3D representation satisfying a replacement criterion; and
replacing the first set of the points in the 3D representation with a planar element having an appearance provided by one or more images depicting a surface of the physical environment.

12. The first device of claim 11, wherein the operations further comprise providing the 3D representation to a second device different than the first device, wherein the second device provides a view based on the points and the planar element, wherein an appearance of the planar element in the view is based on the one or more images of the surface.

13. The first device of claim 12, wherein the first device and the second device concurrently provide views of the physical environment during a communication session.

14. The first device of claim 11, where the surface is a flat surface, wherein the planar element comprises a mesh defining the flat surface, wherein an appearance of the mesh is defined based on the one or more images.

15. The first device of claim 11, wherein the planar element is defined using less data than the first set of the points.

16. The first device of claim 11, wherein the first set of the points is identified by:
determining a confidence value that each point of the first set of the points represents a portion of a flat surface; and
determining that the confidence value of each point of the first set of the points exceeds a threshold.

17. The first device of claim 16, wherein the first set of the points is further identified based on determining that the flat surface exceeds a size threshold.

18. The first device of claim 1, wherein the replacing occurs in real time during a scanning process in which:
sensor data is obtained over a time period;
active depth sensing and imaging are used to generate the points for inclusion in the 3D representation as sensor data is received during the time period; and
points are selectively replaced with one or more planar elements based on the replacement criterion during the time period.

19. The first device of claim 1, wherein the operations further comprise updating an appearance of the planar element as new sensor data is obtained, wherein updating the appearance of the planar element is based on determining that the new sensor data satisfies an image criterion.

20. A non-transitory computer-readable storage medium storing program instructions executable via one or more processors to perform operations comprising:
generating a three-dimensional (3D) representation of a physical environment, the 3D representation comprising points each having a 3D location and representing a portion of the physical environment;
identifying a first set of the points of the 3D representation satisfying a replacement criterion; and
replacing the first set of the points in the 3D representation with a planar element having an appearance provided by one or more images depicting a surface of the physical environment.

21-28. (canceled)
